(19) United States
(12) Patent Application Publication
(10) Pub. No.: US 2003/0010126 A1
(43) Pub. Date: Jan. 16, 2003

(54) Non-intrusive method and device for characterising flow pertubations of a fluid inside a pipe

(76) Inventors: Thierry Romanet, La Penne Sur Huveaume (FR); Jean Daniel Reber, Pertuis (FR)

Correspondence Address: DENNISON, SCHULTZ & DOUGHERTY, 1745 JEFFERSON DAVIS HIGHWAY, ARLINGTON, VA, 22202, US

(21) Appl. No.: 10/181,924

(22) PCT Filed: Feb. 8, 2001
(86) PCT No.: PCT/FR01/00365

(30) Foreign Application Priority Data
Feb. 11, 2000 (FR) 00/01755

(51) Int. Cl. G01N 29/00

(52) U.S. Cl. 73/649

(57) ABSTRACT

The invention provides a non-intrusive method of characterizing flow disturbances of a fluid inside a cylindrical pipe (2). According to the invention, in order to determine flow disturbances, the method consists in using variation in the pressure of the fluid as a first indicator:

by placing at least one clamping collar around the pipe, the collar being provided with at least one deformation sensor sensitive to the deformation to which the pipe is subject due to variations of fluid pressure;

by measuring the deformation variations detected by the deformation sensor; and

by determining the variations of fluid pressure inside the pipe from measurements of deformation variations detected by said sensor.

The invention relates to the technical field of characterizing flow disturbances in the broad sense, relating to a fluid inside a cylindrical pipe.

The invention finds a particularly advantageous application in detecting or measuring flow disturbances for a gaseous, liquid, or multiphase fluid flowing in a pipe, in particular an undersea pipe placed at great or even very great depth.

In the state of the art, it is frequently necessary to be able to characterize the disturbances in the flow of a fluid, e.g. disturbances corresponding to variation in pressure or flow rate, or to a change in the uniformity of the fluid likely to give rise to a plurality of flow regimes of intermittent type, each presenting a “plug” of liquid followed by a “pocket” of high pressure gas.

In order to detect flow disturbances, a first known method relies on the difference between the electrical properties of the components of a multiphase fluid flowing inside the pipe. Thus, it is possible to perform capacitance, inductance, or conductivity measurements on the fluid in order to detect instability in the multiphase flow, and in particular in order to detect the appearance of liquid plugs, insofar as the dielectric characteristics of pockets of gas and of liquids are very different. Apparatus is thus known based on the impedance imaging technique which consists in studying the response of the fluid to alternating electrical excitation at low voltage. Such a system comprises an excitation electrode delivering an electrical current and a series of measurement electrodes for determining the distribution of currents that are picked up. Such a distribution reflects the manner in which lines of current pass through the liquid and round the gas which conducts electricity less well than the liquid. It is thus possible to obtain a genuine map of the flow.

Although such a method makes it possible to detect flow disturbances, it suffers from the drawback of being intrusive, i.e. of requiring access to the inside of the pipe and also of requiring electrical excitation to be implemented. Furthermore, such apparatus is not easily installed on pipes and consumes relatively large amounts of energy. Such apparatus turns out to be particularly ill-suited for installation on a fluid transport pipe, in particular an undersea pipe placed at great or very great depths.

Analogous drawbacks can be mentioned for the apparatuses described in documents U.S. Pat. No. 3,930,402 and DE 35 11 899 implementing intrusive measurement techniques requiring direct access to the inside of the pipe.

The state of the art includes a second method relying on photon attenuation, based on the fact that different fluids present different absorption properties with respect to photon radiation. The sources of radiation that are most commonly used, particularly in the oil industry, are gamma ray sources.

Such a method presents the feature of being non-intrusive and of not requiring any particular maintenance, nor of requiring large amounts of energy to be supplied, insofar as the sources of radiation used are of chemical origin. Nevertheless, the use of radioactive systems comes up against major legislative and regulatory problems, in particular when such a system is to be fitted to an underwater pipe.

An analysis of the state of the art leads to the conclusion that there is a need for a technique that is suitable for characterizing the flow disturbances of a fluid inside a pipe and that is designed to be non-intrusive, presenting low energy consumption and being simple to install and maintain.

The invention thus seeks to satisfy this need by proposing a non-intrusive method of characterizing flow disturbances of a fluid inside a cylindrical pipe.

According to the invention, in order to determine flow disturbances, the method consists in using variation in fluid pressure as a first indicator:

by placing at least one clamping collar around the pipe, the collar being provided with at least one deformation sensor sensitive to the deformation to which the pipe is subject due to variations in the pressure of the fluid;

by measuring the variations in deformation detected by the deformation sensor; and

by determining the variations in the pressure of the fluid inside the pipe from the measured variations in deformation as detected by said sensor in order to determine the flow disturbances of the fluid inside the pipe.

Another characteristic of the invention seeks to propose non-intrusive apparatus for characterizing flow disturbances of a fluid inside a cylindrical pipe.

According to the invention, the apparatus comprises at least a system for measuring the pressure of the fluid and comprising:

at least one clamping collar provided with at least one deformation sensor sensitive to the deformation to which the pipe is subjected by variations in the pressure of the fluid;

clamping means for clamping said collar around the pipe; and

measuring and processing means associated with said sensor serving to determine the variations of fluid pressure inside the pipe from the measured deformation variations detected by said sensor.

Various other characteristics appear from the following description with reference to the accompanying drawings which show embodiments and implementations of the invention as non-limiting examples.

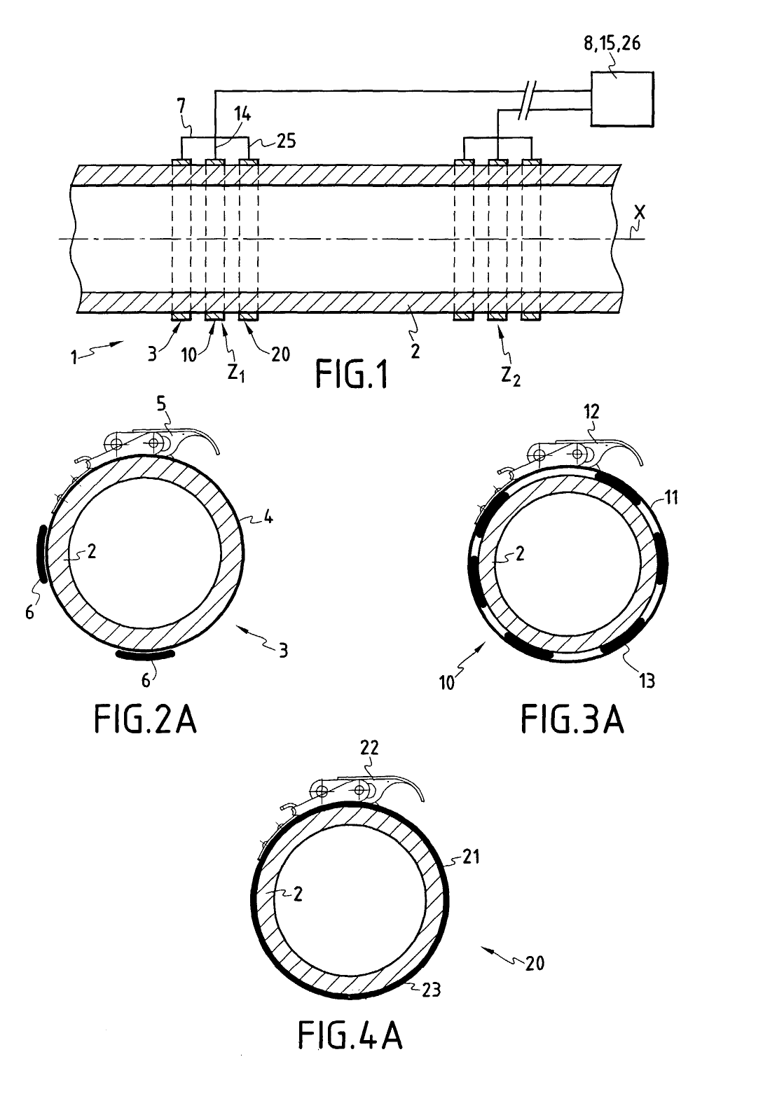

FIG. 1 is a diagrammatic section view of an embodiment of apparatus in accordance with the invention.

FIGS. 2A, 3A, and 4A are cross-section views through the apparatus shown in FIG. 1, and show various measurement systems in accordance with the invention.

FIGS. 2B, 3B, and 4B are curves representative of the measurements performed by the systems shown respectively in FIGS. 2A, 3A, and 4A.

FIG. 1 shows apparatus 1 for characterizing the flow disturbances of a fluid inside a cylindrical transport pipe 2 having a longitudinal axis X. The fluid can be of any kind, e.g. liquid, gaseous, or multiphase, such as a petroleum fluid, for example. By way of example, the pipe 2 is considered as being horizontal, however it could naturally present any kind of orientation, including vertical. The pipe 2 may be made of various materials such as steel, for example, and it may be installed in open air or in immersed at great or even very great depth.

The apparatus 1 is adapted to characterize a flow disturbance of the fluid, i.e., for example, a change in pressure, flow rate, uniformity, etc. The apparatus 1 comprises a least one system 3 for measuring the pressure of the fluid flowing inside the pipe 2. The measurement system 3 comprises at least one clamping collar 4 mounted in localized manner on the outside of the pipe 2 in a measurement zone Z₁. As can be seen more clearly in FIG. 2A, the clamping collar 4 is fitted with any type of clamping means 5 suitable for enabling the collar 4 to fit closely to the outside shape of the pipe 2. The clamping means 5 serve also to lock the collar in a determined position around the outside wall of the pipe 2. The clamping means 5 are preferably adjustable enabling the pressure difference that appears under the collar between the inside and the outside of the pipe 2 to be adjusted. This makes it possible to adjust the values of the pressure variations that are detected.

The clamping collar 4 is fitted with at least one deformation sensor 6, and in the example shown in FIG. 2A it is fitted with two such sensors, each of which is responsive to the deformations to which the pipe 2 is subject due to variations in the pressure of the fluid. For example, each pressure sensor 6 is of the strain gauge type, either resistive or optical fiber. Each deformation sensor 6 could also be of the type comprising an optical fiber wound around the pipe 2. The deformation to which the wall of the pipe 2 is subjected represents the action of the fluid inside the pipe and thus variations in the pressure of the fluid. As a result, elongation measured by the sensor on an external generator line of the pipe 2 is proportional to the diameter of the pipe multiplied by the difference between the pressure inside and the pressure outside the pipe, divided by twice the wall thickness of the pipe 2.

The deformation sensor(s) 6 is/are connected by a connection 7 to measuring and processing means 8 enabling variations in the pressure of the fluid inside the pipe 2 to be determined on the basis of measured variations in deformation detected by each deformation sensor 6. By way of example, FIG. 2B shows variations in deformation as recorded by a deformation sensor 6 as a function of time t.

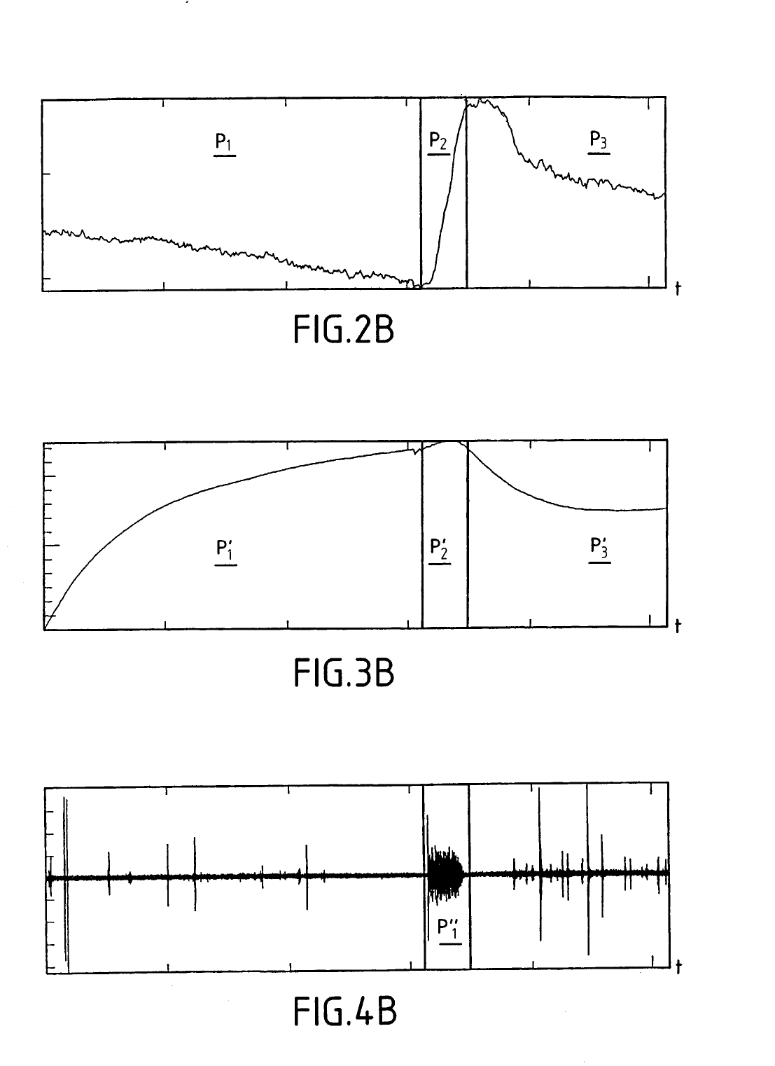

In a preferred embodiment, the apparatus 1 also has a system 10 for measuring variations in heat exchange that occur between the fluid and the pipe 2. As can be seen more clearly in FIG. 3A, such a measuring system 10 comprises at least one clamping collar 11 mounted in localized manner around the pipe 2 in the measurement zone Z₁. The clamping collar 11 is fitted with clamping means 12 designed to enable the collar 11 to fit as closely as possible to the outside shape of the pipe 2. The clamping means 12 also serve to lock the collar in a determined position around the outside wall of the pipe 2.

The clamping collar 11 is fitted with at least one sensor 13 for measuring heat flow, and is preferably provided with a series of such sensors each responsive to heat exchange taking place between the fluid and the pipe 2. Each sensor 13 for measuring heat flow is mounted to respond to heat exchange between the pipe 2 and the fluid flowing inside the pipe (i.e. in watts per square centimeter (W/cm²)). In an embodiment, each heat flow sensor 13 is constituted by a heat flow meter mounted on the collar 11 which is constituted by a flexible strap, such as a neoprene strap. It should be observed that the clamping collar 11 may also include a temperature probe for measuring the temperature of the outside surface of the pipe 2. Each heat flow measuring sensor 13 is connected via a connection 14 of any type to measuring and processing means 15 enabling variations in heat flow to be determined from the measured heat exchange variations detected by each of the heat flow sensors 13. By way of example, FIG. 3B shows the variations in heat flow as measured by a flow sensor 13 over time t.

In a preferred embodiment, the apparatus 1 of the invention also comprise a system 20 for measuring noise and vibration generated by the flow of fluid, e.g. by friction between the fluid and the pipe wall or by hammer blows. Such a system 20 for measuring noise and vibration comprises at least one clamping collar 21 mounted in localized manner on the outside of the pipe 2 in the measurement zone Z₁. As can be seen more clearly in FIG. 4A, the clamping collar 21 is provided with clamping means 22 adapted to enable the collar 21 to fit as closely as possible to the outside shape of the pipe 2. The clamping means 22 also enable the collar to be clamped in a determined position around the outside wall of the pipe 2. The clamping collar 22 is fitted with at least one vibration sensor 23 responsive to noise and vibration produced by the flow of fluid inside the pipe 2. For example, each vibration sensor 23 is constituted by an accelerometer of piezoelectric type or an optical fiber or of piezoelectric films (PVDF, copolymer, PZT, etc.). Each vibration sensor 23 is connected via a connection 25 to measuring and processing means 26 enabling variations of noise and vibration produced by the flow of fluid inside the pipe to be determined by measuring the vibration detected by each vibration sensor 23. By way of example, FIG. 4B shows how the vibrations detected by a vibration sensor 23 vary over time t.

In accordance with the above description, the method of the invention consists in characterizing flow disturbances by using at least a first indicator, namely variation in the pressure of the fluid flowing inside the pipe 2. In this respect, a system 3 for measuring fluid pressure is installed on said pipe in a measurement zone Z₁. Such a measuring system 3 presents the advantage of being non-invasive and non-intrusive since it only requires a collar to be mounted around the pipe 2. Such a system 3 serves to measure variation in the pressure of the fluid, from which it is possible to deduce disturbances in the flow of the fluid. According to an advantageous implementation, provision is made to use the measuring and processing means 8 to compare pressure variations as measured with at least one reference model of pressure variation in order to characterize a type of flow disturbance. By way of example, and as shown in FIG. 2B, in order to characterize the presence of a liquid plug, a reference model can be defined that comprises three successive stages, namely:

a first stage P₁ during which pressure decreases slowly;

a second stage P₂ during which pressure rises strongly and suddenly, corresponding to the passage of a liquid plug which is being pushed along by a pocket of high pressure gas; and

a third stage P₃ during which pressure decreases slowly.

In a preferred implementation, the method consists in characterizing flow disturbances by also making use, if necessary, of a second indicator, namely variations in heat exchange between the fluid and the pipe 2. In this respect, a system 10 for measuring variations of heat exchange between the fluid and the pipe 2 is installed in the measurement zone Z₁. Such a measuring system 10 also presents the advantage of being non-invasive since it only requires a collar to be mounted around the pipe 2. Such a system 10 enables variations in heat exchange to be measured from which it is possible to deduce a disturbance in the flow of the fluid. In an advantageous implementation, provision is made for the measuring and processing means 15 to compare measured heat exchange variations with at least one reference model of heat exchange variation serving to characterize a type of flow disturbance. For example, as shown in FIG. 3B, in order to characterize the presence of a plug of liquid, a reference model can be defined comprising three successive stages, namely:

a first stage P′₁ during which heat flow increases rapidly towards an asymptotic value;

a second stage P′₂ during which there appears a rapid increase of short duration in the heat flow corresponding to the passage of a plug of liquid which leads to a large amount of heat being exchanged because of the presence of the liquid phase; and

a third stage P′₃ during which the heat flow decreases progressively.

In a preferred implementation, the method of the invention consists in characterizing flow disturbances by using a third indicator, namely the noise and vibration produced by the flow of fluid inside the pipe 2. To this end, a system 20 for measuring noise and vibration is installed in the measurement zone Z₁. Such a measuring system 20 presents the advantage of being non-invasive since it only requires a collar to be mounted around the pipe 2. Such a system 20 enables the noise and vibration caused by the flow of fluid to be measured, from which it is possible to deduce a disturbance in the flow of fluid. In an advantageous implementation, provision is made for the measuring and processing means 26 to compare variations in noise and vibration relative to a reference model of variation in noise and vibration suitable for characterizing a type of flow disturbance. For example, in order to characterize the presence of a liquid plug, a reference model can be defined that comprises a phase P″₁ of given duration during which the measured values exceed a determined threshold. This stage P″₁ corresponds to the passage of a liquid plug.

As can be seen from the above description, the particular type of a flow disturbance is characterized by using the first indicator, optionally in association with the second and/or third indicator. Advantageously, measurements of pressure variation, of heat flow variation, and of noise and vibration variation are performed simultaneously so as to make it possible on comparison with the respective reference models to verify the type of flow disturbance. Thus, as can be seen clearly in FIGS. 2B, 3B, and 4B, the appearance of a liquid plug detected by the pressure measuring system 3 can be confirmed by the information given by the systems 10 and/or 20 for measuring heat flow and/or noise and vibration.

In the embodiment shown in FIG. 1, it is possible to envisage setting up on the pipe 2 a second measurement zone Z₂ at a distance from the first zone Z₁ along the longitudinal axis X. Clamping collars are installed in said second measurement zone Z₂ carrying deformation sensors and/or heat flow sensors and/or vibration sensors belonging to respective systems 3, 10, and 20 for measuring pressure, heat flow, and noise and vibration. The measurements performed by the sensors of the same kind belonging to the two zones are correlated with each other in order to determine the speed at which the disturbance is propagating and also in order to determine its dimensional characteristics.

1/ A non-intrusive method for characterizing flow disturbances of a fluid inside a cylindrical pipe (2), the method being characterized in that in order to determine flow disturbances it consists in using variation in the pressure of the fluid as a first indicator:
by placing at least one clamping collar (4) around the pipe, the collar being provided with at least one deformation sensor (6) sensitive to the deformation to which the pipe is subject due to variations in the pressure of the fluid;
by measuring the variations in deformation detected by the deformation sensor; and
by determining the variations in the pressure of the fluid inside the pipe from the measured variations in deformation as detected by said sensor in order to determine the flow disturbances of the fluid inside the pipe.

2/ A method according to claim 1, characterized in that it consists in comparing the variations in fluid pressure as determined from the measured deformation variation with at least one reference model of pressure variation suitable for characterizing a type of flow.

3/ A method according to claim 2, characterized in that it consists in taking a reference model of pressure variation comprising three successive stages, namely:
a first stage (P₁) during which pressure decreases;
a second stage (P₂) during which pressure increases quickly and strongly, corresponding to the passage of a liquid plug; and
a third stage (P₃) during which pressure decreases.

4/ A method according to claim 1, characterized in that it consists in controlling the clamping of the collar (4) on the pipe in order to adjust the values of the detected pressure variations.

5/ A method according to claim 1, characterized in that in order to determine flow disturbances, it consists in using variations in heat exchange between the fluid and the pipe as a second indicator:
by placing at least one clamping collar (11) around the pipe (2), the collar being provided with at least one sensor (13) for measuring heat flow that is responsive to heat exchange between the fluid and the pipe;
by measuring the heat exchange variations detected by the heat flow sensor; and
by determining heat flow variations from the measured heat exchange variation detected by said sensor.

6/ A method according to claim 1, characterized in that in order to determine flow disturbances, it consists in using noise and vibration introduced by the flow of the fluid as a third indicator:
by placing at least one clamping collar (21) around the pipe (2), the collar being provided with at least one vibration sensor (23) sensitive to the noise and vibration produced by the flow of the fluid;
by measuring the noise and vibration variations detected by the vibration sensor (23); and
by determining the noise and vibration variations produced by the flow of the fluid inside the pipe from the measured vibrations detected by said sensor.

7/ A method according to claim 5 or claim 6, characterized in that it consists in comparing the heat flow variations or the noise and vibration variations with at least one reference model respectively of heat flow variation or of noise and vibration variation enabling a type of flow disturbance to be characterized.

8/ A method according to claim 7, characterized in that it consists in taking a reference model of heat exchange variation that comprises three successive stages, namely:
a first stage (P′₁) during which heat flow increases asymptotically towards a value;
a second stage (P′₂) during which a rapid increase of short duration appears in the heat flow corresponding to the passage of a liquid plug; and
a third stage (P′₃) during which the heat flow decreases progressively.

9/ A method according to claims 1, 5, 6, and 7, characterized in that it consists in simultaneously measuring deformation variations, heat exchange variations, and noise and vibration variations in such a manner as to make it possible to verify the type of flow disturbance on making comparisons with the respective reference models.

10/ A method according to claims 1, 5, or 6, characterized in that it consists:
placing clamping collars in two measurement zones (Z₁, Z₂) that are spaced apart from each other along the pipe, the collars being provided with deformation and/or heat flow and/or vibration sensors; and
in correlating measurements performed by sensors of the same kind in order to obtain the speed at which the disturbance propagates and also its dimensional characteristics.

11/ A non-intrusive apparatus for characterizing flow disturbances of a fluid inside a cylindrical pipe, the apparatus being characterized in that it comprises at least one system (3) for measuring fluid pressure and comprising:
at least one clamping collar (4) provided with at least one deformation sensor (6) sensitive to the deformation to which the pipe is subjected by variations in the pressure of the fluid;
clamping means (5) for clamping said collar around the pipe (2); and
measuring and processing means (8) associated with said sensor serving to determine the variations of fluid pressure inside the pipe from the measured deformation variations detected by said sensor.

12/ Apparatus according to claim 11, characterized in that the deformation sensor (6) is implemented by a strain gauge type sensor, a resistive strain gauge or an optical fiber, e.g. wound around the pipe.

13/ Apparatus according to claim 11, characterized in that it also comprises a system (10) for measuring heat exchange variations between the fluid and the pipe, the system comprising:
at least one clamping collar (11) provided with at least one sensor (13) for measuring heat flow and sensitive to heat exchange between the fluid and the pipe;
clamping means (12) for clamping said collar around the pipe (2); and
measuring and processing means (15) associated with said sensor enabling variations in heat flow to be determined from measured heat exchange variations detected by the heat flow sensor.

14/ Apparatus according to claim 11 or claim 12, characterized in that it also comprises a system (20) for measuring noise and vibration, the system comprising:
at least one clamping collar (21) provided with at least one vibration sensor (23) sensitive to noise and vibration produced by the flow of fluid;
clamping means (22) for clamping said collar around the pipe; and
measuring and processing means (26) associated with the sensor, enabling variations in the noise and vibration produced by the flow of fluid inside the pipe to be determined from measurements of vibrations detected by said sensor.

15/ Apparatus according to claim 11, 13, or 14, characterized in that it comprises measuring and processing means (8, 15, 26) adapted to compare variations in pressure, heat flow, or noise and vibration with at least one reference model respectively of heat flow variation or noise and vibration variation enabling a type of flow disturbance to be characterized.
